(19) United States
(12) Patent Application Publication
(10) Pub. No.: US 2022/0051152 A1
(43) Pub. Date: Feb. 17, 2022

(54) METHOD AND SYSTEM FOR COMPLETING AND MANAGING WORKFLOWS

(71) Applicant: TALK 5 PTY LTD., Pyrmont NSW (AU)

(72) Inventor: George BANCS, Miranda, New South Wales (AU)

(21) Appl. No.: 17/276,115

(22) PCT Filed: Sep. 13, 2019
(86) PCT No.: PCT/IB2019/057721

§ 371 Date: Mar. 12, 2021

(30) Foreign Application Priority Data
Sep. 13, 2018 (AU) 2018903434

(51) Int. Cl. G06Q 10/06; G10L 15/22; G10L 15/26; G06F 40/58; G10L 15/00

(52) U.S. Cl. CPC G06Q 10/0633; G10L 15/22; G10L 15/005; G06F 40/58; G10L 15/26

(57) ABSTRACT

A method of completing and managing workflows, the method comprising: displaying text questions and/or generating voice questions asking a user for voice answers to identify and complete a workflow, and converting voice answers from the user into text answers to complete the workflow.

### FIELD

The present invention relates to a computer-implemented method and system for completing and managing workflows.

### BACKGROUND

Workflows, such as audits, inspections, surveys and checklists are traditionally completed by manually filling in paper forms or paper checklists. Once completed, the paper checklists must be stored and managed, often with a view to create an audit trail to show compliance with relevant regulations.

For example, audits of worksites are conducted regularly to ensure compliance with a wide range of policies and regulations, including safety, quality and environmental regulations. A specific example is worksite safety audits, such as “Take 5” pre-start safety checklists, that help workers and contractors who are working on new or external worksites reduce their exposure to occupational health and safety (OHS) risks and hazards.

OHS regulations in many industries, such as the building and construction industry, require pre-start safety audits to be completed each day before work starts on a task at a worksite. In addition, post-task audits, such as quality audits, may also need to be completed after work on the task has ended.

The use of manually filled, paper checklists for workflows suffer from several drawbacks. Sometimes, a completed checklist is lost, or an incorrect checklist is used for the workflow task. Other times, a checklist is not completed before work starts on the workflow task, but someone fills out the checklist, or a portion of the checklist, after work on the workflow task has started. This makes the answers to the checklists unreliable, at least to a degree, and certainly not useful to establish an audit trail to show that correct workflow procedures were followed.

In this context, there is a need for an improved method and system for completing and managing workflows.

### SUMMARY

According to the present invention, there is provided a method of completing and managing workflows, the method comprising:

displaying text questions and/or generating voice questions asking a user for voice answers to identify and complete a workflow;

converting voice answers from the user into text answers to complete the workflow.

The method may further comprise storing the completed workflow in an audit trail management system.

The workflow may comprise an audit, an inspection, a survey, or a checklist.

The audit may comprise a pre-start audit or a post-task audit.

The audit may comprise a safety audit, a quality audit or an environmental audit.

The audit may, for example, comprise a Take 5 pre-start safety checklist.

The voice answers from the user may be converted into text answers using a speech-to-text service.

A system for completing and managing workflows, the system comprising:

a memory to store instructions;

one or more processors to execute instructions stored in the memory to:

display text questions and/or generate voice questions asking a user for voice answers to identify and complete a workflow; and

convert voice answers from the user into text answers to complete the workflow.

The workflow may comprise an audit, an inspection, a survey or a checklist.

### BRIEF DESCRIPTION OF DRAWINGS

Embodiments of the invention will now be described by way of example only with reference to the accompanying drawings, in which:

FIG. 1 is an example flow chart of a method for completing and managing worksite audits according to an example embodiment of the present invention;

FIG. 2 is an example high level architecture and dataflow diagram illustrating an example system for completing and managing worksite audits according to an example embodiment of the present invention; and

FIGS. 3 to 8 are example graphical user interfaces (GUIs) generated by an example speech-to-text app for completing and managing worksite audits according to an example embodiment of the present invention.

### DESCRIPTION OF EMBODIMENTS

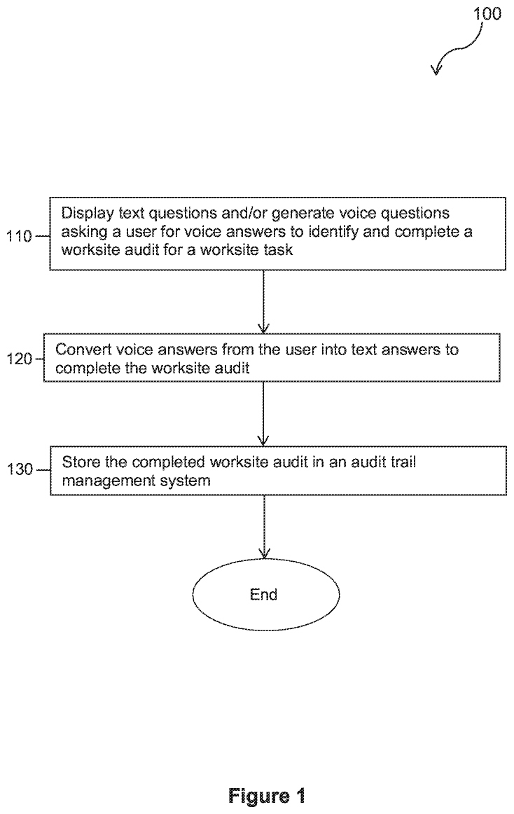

Referring to FIG. 1, an example method 100 for completing and managing a workflow in the form of a worksite audit according to an example embodiment of the present invention starts at step 110 by displaying text questions and/or generating voice questions asking a user for voice answers to identify and complete a worksite audit for a worksite task. The worksite audit may comprise a safety audit, a quality audit, an environmental audit, or any other type of audit conducted on worksites. The worksite audit may, for example, comprise a pre-start audit or a post-task audit. For example, the worksite audit may comprise a Take 5 pre-start safety checklist.

Next, at step 120, the voice answers from the user may be converted into text answers to complete the worksite audit. The voice answers may be converted into text answers using, for example, a speech-to-text service.

The method 100 may end at step 130 where the completed worksite audit may be stored in an audit trail management system.

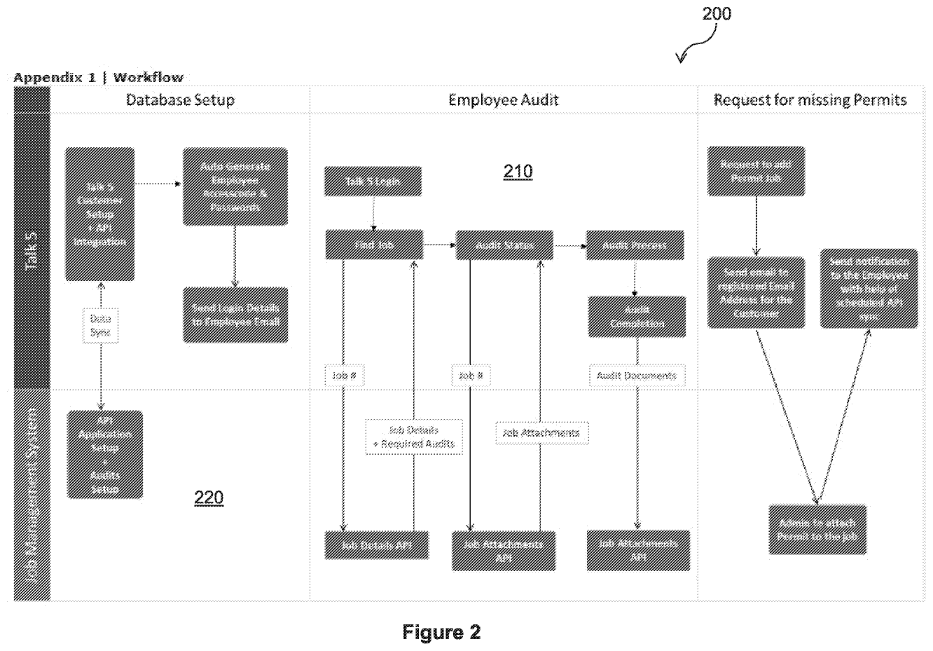

FIG. 2 illustrates an example high level architecture and dataflow diagram illustrating an example client-server database system 200 for implementing the method 100 as a mobile software application (or “app”) 210 running on a mobile computing device such as a smartphone, tablet or laptop.

The speech-to-text worksite audit app 210 may interface via application programming interfaces (APIs) to a worksite task (or “job”) management system 220. The completed worksite audits may be stored in the job management system 220 as part of an audit trail management system. The speech-to-text worksite audit app 210 may further interface via an API to a speech-to-text service (not shown). The speech-to-text worksite audit app 210 may, for example, be provided to users as software as a service (SaaS).

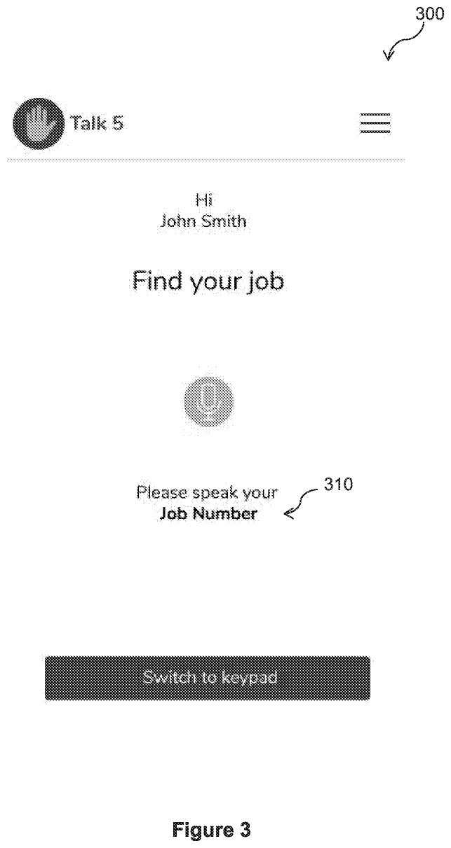

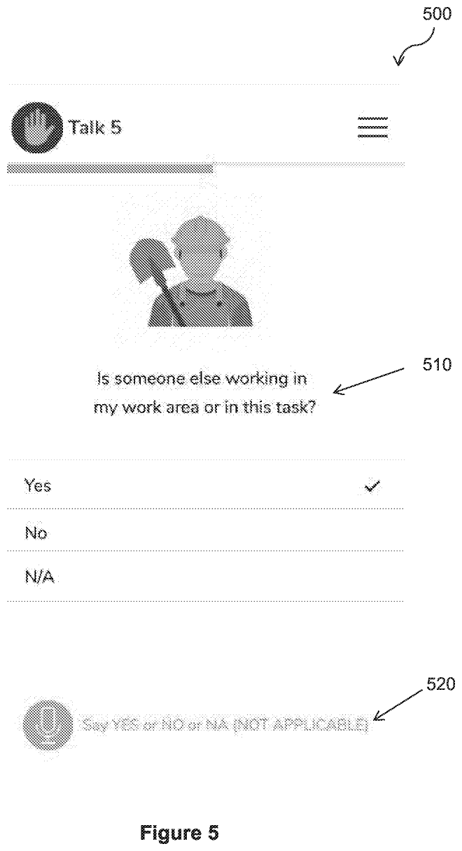

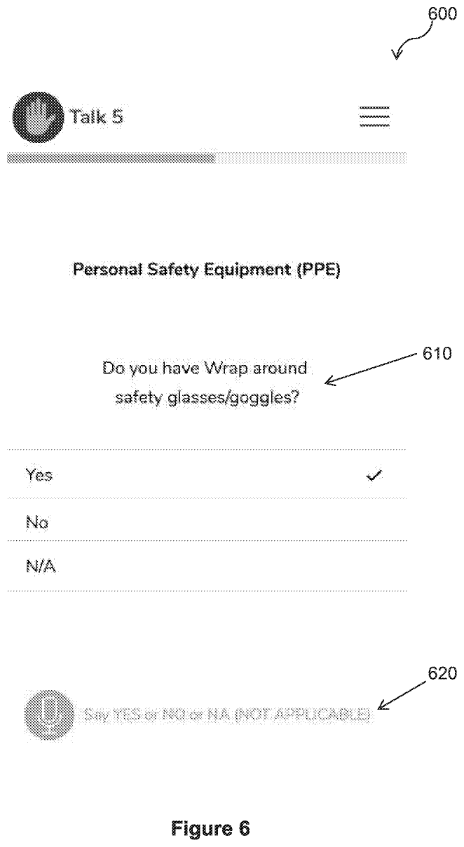

Referring to FIGS. 3 to 8, the method 100 may be performed using GUIs generated by the speech-to-text worksite audit app 210. FIG. 3 illustrates an example GUI 300 that may display a text question 310 “Please speak your Job Number” asking the user for a voice answer to identify a worksite task for which a worksite audit must be completed. In addition to the text question 310, a corresponding voice question may be generated by the speech-to-text worksite audit app 210 asking the user for the voice answer. The voice answer from the user may be converted by the speech-to-text service into a text answer that is used to retrieve the correct pre-start audit from the job management system 220.

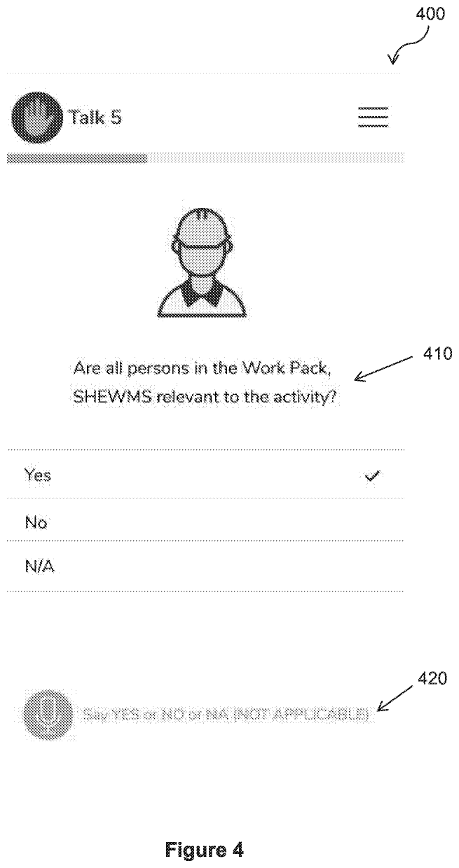

FIGS. 4 to 6 illustrates examples GUI 400, 500, 600 that may display text questions 410, 510, 610 to the user asking for voice answers 420, 520, 620 “Say YES or NO or NA (NOT APPLICABLE)” to individual audit items of the worksite audit. Again, in addition to the text questions 410, 510, 610, corresponding voice questions may be generated by the speech-to-text worksite audit app 210 asking the user for the voice answers. Again, the voice answers 420, 520, 620 from the user may be converted by the speech-to-text service into a text answers to complete the individual audit items of the worksite audit.

The worksite audit app 210 may be configured to respond with custom questions, actions, and/or alerts based on the voice answers given by the user. For example, the worksite audit app 210 may generate an alert or a warning if the answer to a question may indicate possible dangerous working conditions, or falls outside safe parameters. As a specific example, if the user answers “NO” to the question “Have you checked the power lines?”, then a warning message with danger about powerlines can be displayed before the app proceeds to the next question. Further examples may include, changing or skipping the sequence of questions based on a user's answer, generating an alert or warning, which may, for example, inform a user of possible unsafe working conditions. The worksite audit app 210 may also request the user to upload a photograph or video material in evidence of a given answer.

In a further example, the worksite audit app 210 may be configured to generate an action, such as a maintenance work task, based on the voice answer provided by the user. The generated action may also include a further workflow which may be assigned to another user. The worksite audit app may therefore be used to automate multiple dependant work tasks, based on the status of a primary work task. The worksite audit app 210 may also, for example, be configured to save and exit the audit in response to a voice command or voice answer provided by the user, which may, for example, allow a user to complete a task before continuing the audit. The worksite audit app may be configured to generate and send notification emails to a specific person or group of people, in response to specific voice answers.

The worksite audit app 210 may be configured to provide multi language support such that the app supports multiple input and output languages, allowing the voice answers 420, 520, 620 to be given in any of a number of supported languages. The worksite audit app 210 may be configured to translate the audit answers and audit questions such that these questions and answers can be asked and answered in any of a number of supported languages. For example, the worksite audit app 210 may make use of an application such as Google translate to convert audit answers to be read, or for audit reports to be generated, in multiple languages including English. Advantageously this allows users to complete audits in their own preferred language (if supported). The worksite audit app 210 may be configured to determine the language of the user automatically, based on the voice answers, and provide further questions in the preferred language accordingly.

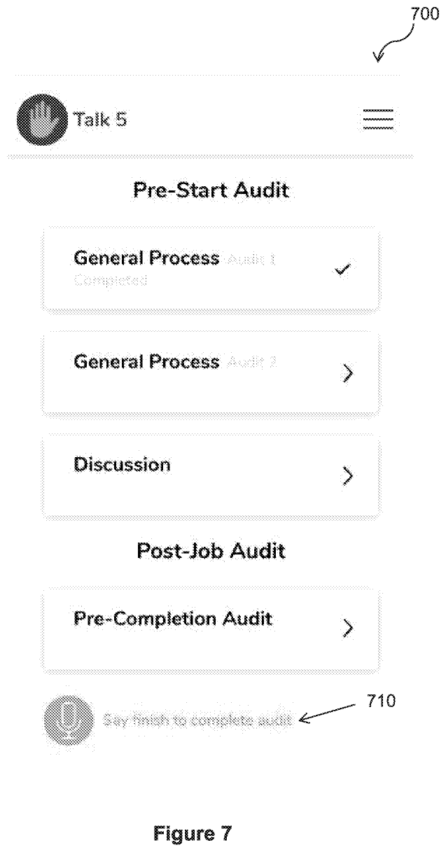

When text answers to the individual audit items of the worksite audit have been converted into a text file, the method 100 and system 200 may generate an example GUI 700 illustrated in FIG. 7 that may display a text question 710 “Say finish to complete audit” which asks the user for a voice answer to confirm that the worksite audit for the worksite task has been completed. As described above, a corresponding voice question may also be generated asking the user for the voice answer “finish.” The voice answer “finish” from the user may then be converted by the speech-to-text service into a text answer that identifies that the worksite audit for the worksite task has been completed. The completed text file for the worksite audit for the worksite task may then be stored in the job management system 220 to provide an audit trail for compliance. The audit or parts of the audit, including both voice questions and voice answers, may be recorded. The recorded audit may be stored as an audio file, or as a transcribed text file. Audit recordings may be used for review to, for instance, improve the system and identify and/or clarify any conflicting information within the audit.

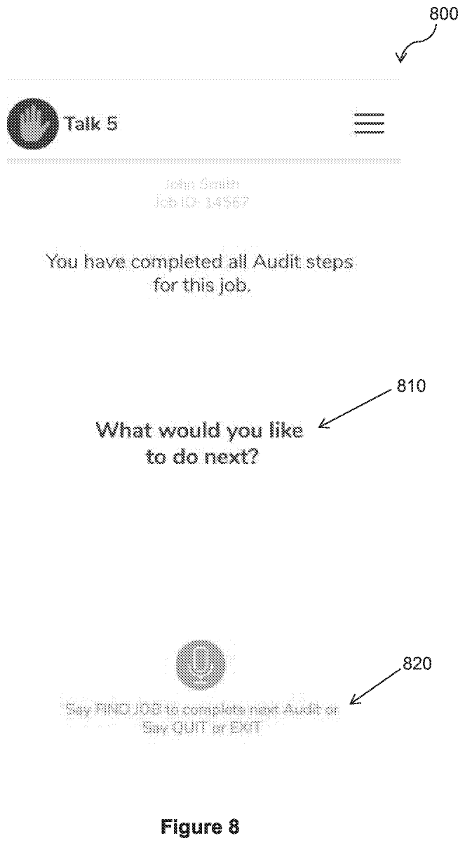

After the worksite audit for the worksite task has been completed, the method 100 and system 200 may generate an example GUI 800 illustrated in FIG. 8 that may display a text question 810 “What would you like to do next?” asking the user for a voice answer 820 “Say FIND JOB to complete next Audit or Say Quit or Exit.” Again, corresponding voice questions may also be generated for the user to provide voice answers. The user then may either complete another worksite audit for another worksite task, or quit the app.

The worksite audit app 210 may be configured to operate in both online or offline mode depending on network availability. In online mode, the worksite audit app 210 may receive audits, questions and instructions from a remote server and answers provided by the user may be continuously transmitted to and stored on the remote server. In offline mode, audits, questions and instructions may be stored locally on the mobile computing device. In offline mode, the worksite audit app 210 may include a synchronisation function, allowing the worksite app 210 to synchronize with a central server to download new audits, questions and instructions, and to upload answers provided by the user and completed audits to the remote server. For example, the synchronization feature may download audits in text and audio file format. When users provide an answer, the worksite app uses the mobile device's built in speech-to-text function to convert information and synchronize when in online mode.

The worksite audit app 210 may include text and/or voice chat functionality allowing users to exchange text or voice messages in relation to the audits in one-to-one or group messaging. Text and voice chat functionality may advantageously cut down on use of telephone calls and intermediary administration staff. Messaging, especially group messaging, may be helpful in broadcasting information, such as safety information.

The worksite audit app 210 may be configured to generate and distribute an emergency signal in response to a request by a user. For example, if the worksite app is running, a user may generate an emergency signal by using the words “Help” or “S-O-S” and the speech-to-text service may be configured to recognize these words and generate an emergency signal based thereon. This feature may be configured to require further verbal “YES” or “NO” confirmation from a user before an emergency signal is generated.

Embodiments of the present invention provide a speech-to-text worksite audit app that is both generally and specifically useful for completing and managing worksite audits, such as safety audits, quality audits, environmental audits, etc.

For the purpose of this specification, the word “comprising” means “including but not limited to,” and the word “comprises” has a corresponding meaning.

The above embodiments have been described by way of example only and modifications are possible within the scope of the claims that follow.

1. A method of completing and managing workflows, the method comprising:
identifying a secondary language spoken by a user who is to complete a workflow that comprises text questions in a primary language different from the secondary language;
providing the user with voice questions translated into the secondary language from the text questions in the primary language;
in response to the voice questions in the secondary language, receiving voice answers in the secondary language from the user;
translating the voice answers in the secondary language into text answers in the primary language to complete the workflow.

2. The method of claim 1, further comprising storing the completed workflow an audit trail management system.

3. The method of claim 1, wherein the workflow comprises an audit, an inspection, a survey, or a checklist.

4. The method of c a wherein the audit comprises a safety audit, a quality audit or an environmental audit.

5. The method of claim 3, wherein the audit comprises a pre-start audit or a post-task audit.

6. The method of claim 5, wherein the audit comprises a Take 5 pre-start safety checklist.

7. The method of claim 1, wherein translation between the primary language and the secondary language is performed by a translation engine, and conversion between voice and text is performed by a speech-to-text engine.

8. A system for completing and managing workflows, the system comprising:
a memory to store instructions;
one or more processors to execute instructions stored in the memory to:
identify a secondary language spoken by a user who is to complete a workflow that comprises text questions in a primary language different from the secondary language;
provide the user with voice questions translated into the secondary language from the text questions in the primary language;
in response to the voice questions in the secondary language, receive voice answers in the secondary language from the user;
translate the voice answers in the secondary language into text answers in the primary language to complete the workflow.

9. The system of claim 8, wherein the workflow comprises an audit, an inspection, a survey or a checklist.
